(19) United States
(12) Patent Application Publication
(10) Pub. No.: US 2023/0189971 A1
(43) Pub. Date: Jun. 22, 2023

(54) Adjustable Stroller Wheel Cleaning Brush

(71) Applicant: Carlos M. Fernandez, Coconut Creek, FL (US)

(72) Inventor: Carlos M. Fernandez, Coconut Creek, FL (US)

(21) Appl. No.: 17/557,491

(22) Filed: Dec. 21, 2021

(51) Int. Cl. A46B 5/00; B25B 13/14

(52) U.S. Cl. CPC A46B 5/0012; B25B 13/14; A46B 5/0083; A46B 2200/30

(57) ABSTRACT

An adjustable stroller wheel cleaning brush is a cleaning apparatus, that can access multiple locations of a wheel at the same time. Further, the device may also clean wheels of a wide variety of strollers and other similar sized wheels. To accomplish this, the apparatus is designed similar to an adjustable wrench, but with brushes on the wrench head's interior surfaces. More specifically, the wrench head may have an open jaw with an adjustable range enabling the cleaning apparatus to be used on wheels of varying dimensions. Further, the brushes of the apparatus would extend from multiple directions on the wrench head, thereby enabling the cleaning apparatus to clean multiple locations on the wheel. Thus, the stroller wheel cleaning brush is a user friendly, cost efficient, and width adjustable cleaning apparatus that enables efficient cleaning of stroller wheels.

### FIELD OF THE INVENTION

The present invention relates to a cleaning apparatus. More specifically, the present invention is a uniquely designed stroller wheel cleaning brush with width adjustability and multidirectional bristles.

### BACKGROUND OF THE INVENTION

Cleaning accessories and cleaning brushes have a huge market in the current society. A wide variety of cleaning brushes are available in different shapes and sizes as well. People take strollers through a variety of terrains such as grass, mud, hard road, etc. in outdoor spaces, and tiles, granite, wood, carpet etc. in indoor spaces. Cleaning the stroller wheels is hence often a necessity, and a good cleaning brush always comes in handy. However, a cleaning brush that can get into the nooks and crevices of stroller wheels, and other similar sized wheels such as kids' bike wheels etc., is often hard to find. Further, a brush that can access multiple sides of the wheel, and whose width of operation around the wheel may be adjusted, is a rare find in the current market.

An objective of the present invention is to provide a cleaning apparatus with an adjustable jaw and multidirectional bristles, that can access multiple locations of a stroller wheel at the same time. It is further an aim of the present invention to clean wheels of a wide variety of strollers and other similar sized wheels. To accomplish this, the apparatus is designed similar to an adjustable wrench, but with brushes on the wrench head's interior surfaces. According to the present invention, the wrench head may have an open jaw with an adjustable range enabling the present invention to be used on wheels of varying dimensions. Further, the brushes of the present invention would extend from multiple directions on the wrench head, thereby enabling the cleaning apparatus to clean multiple locations on the wheel. Thus, the present invention is a user friendly, cost efficient and width adjustable cleaning apparatus that enables efficient cleaning of stroller wheels.

### BRIEF DESCRIPTION OF THE DRAWINGS

FIG. 1 is top-front-left perspective view of the present invention.

FIG. 2 is a detailed view taken about circle 2 in FIG. 1.

FIG. 3 is an exploded top-front left perspective view of the present invention.

FIG. 4 is a bottom-rear-right perspective view of the present invention.

FIG. 5 is a front side elevational view of the present invention.

FIG. 6 is a rear side elevational view of the present invention.

FIG. 7 is a left side elevational view of the present invention.

FIG. 8 is a right-side elevational view of the present invention.

FIG. 9 is a top plan view of the present invention.

FIG. 10 is a bottom plan view of the present invention.

### DETAIL DESCRIPTIONS OF THE INVENTION

All illustrations of the drawings are for the purpose of describing selected versions of the present invention and are not intended to limit the scope of the present invention.

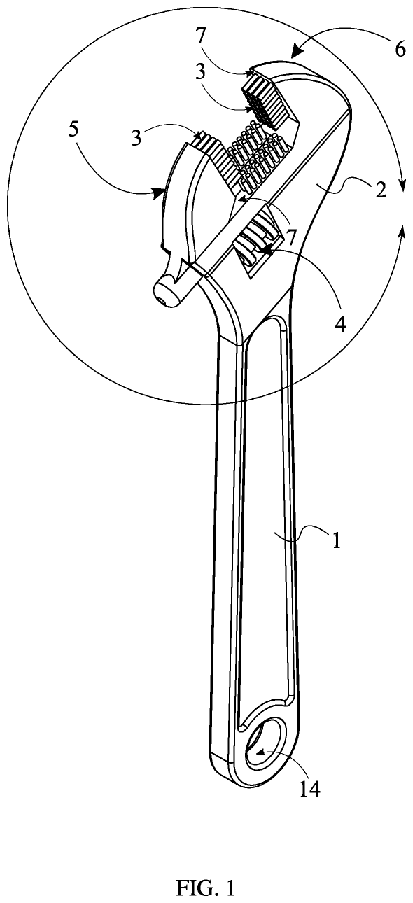

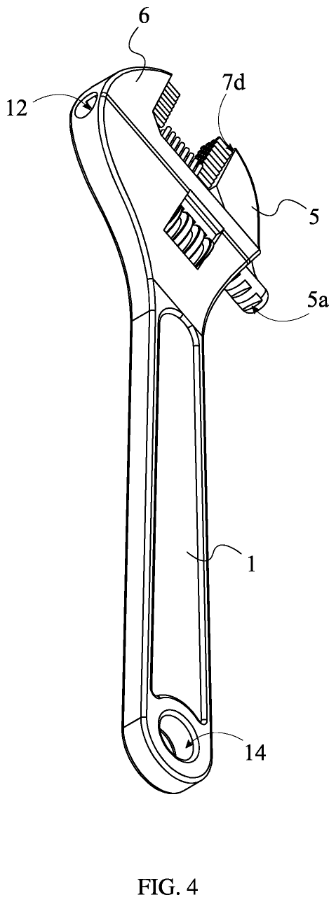

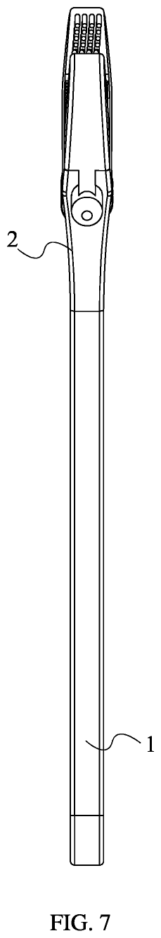

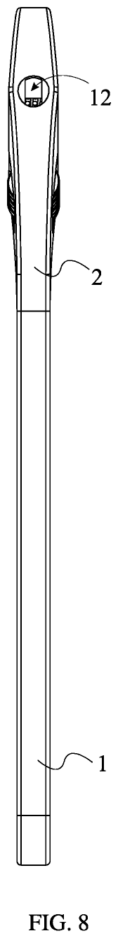

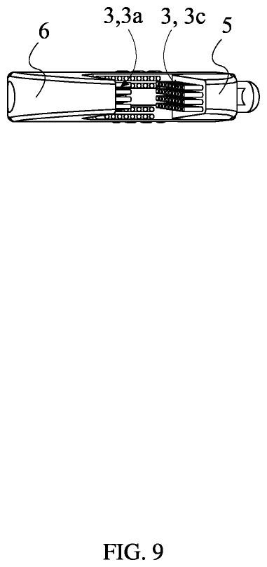

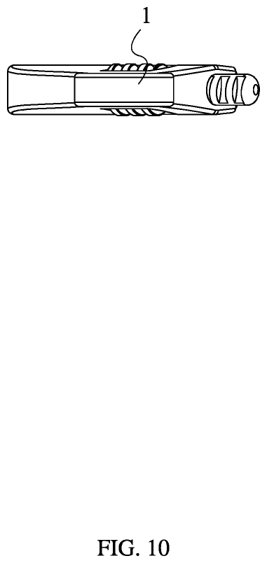

In reference to FIG. 1 through FIG. 10, the present invention is an adjustable stroller wheel cleaning brush. An objective of the present invention is to provide a cleaning apparatus with an adjustable jaw and multidirectional bristles, that can access multiple locations of a wheel at the same time. It is further an aim of the present invention to clean wheels of a wide variety of strollers and other similar sized wheels. To accomplish this, the apparatus is designed similar to an adjustable wrench, but with brushes on the wrench head's interior surfaces. According to the present invention, the wrench head may have an open jaw with an adjustable range enabling the present invention to be used on wheels of varying dimensions. Further, the brushes of the present invention would extend from multiple directions on the wrench head, thereby enabling the cleaning apparatus to clean multiple locations on the wheel. Thus, the present invention is a user friendly, cost efficient, and width adjustable cleaning apparatus that enables efficient cleaning of stroller wheels.

The following description is in reference to FIG. 1 through FIG. 10. According to a preferred embodiment, the present invention comprises a handle 1, a wrench head 2, a plurality of brush heads 3 and a length adjusting device 4. Preferably, the handle 1 and the wrench head 2 are shaped similar to the handle and head of a normal wrench tool and the wrench head 2 is connected to a first terminal end 1a of the handle. Further, the handle 1 and the wrench head 2 are made of a light weight yet sturdy material such as hard plastic, carbon fiber, hard nylon, etc. However, the handle 1 may comprise any other shape, material, components and arrangement of components, as long as the intents of the present invention are not altered. Furthermore, similar to a width adjustable wrench tool, the wrench head 2 comprises a movable jaw 5, and a fixed jaw 6. This is so that the space between the jaws of the wrench head 2 may be adjusted to fit around stroller wheels of varying dimensions.

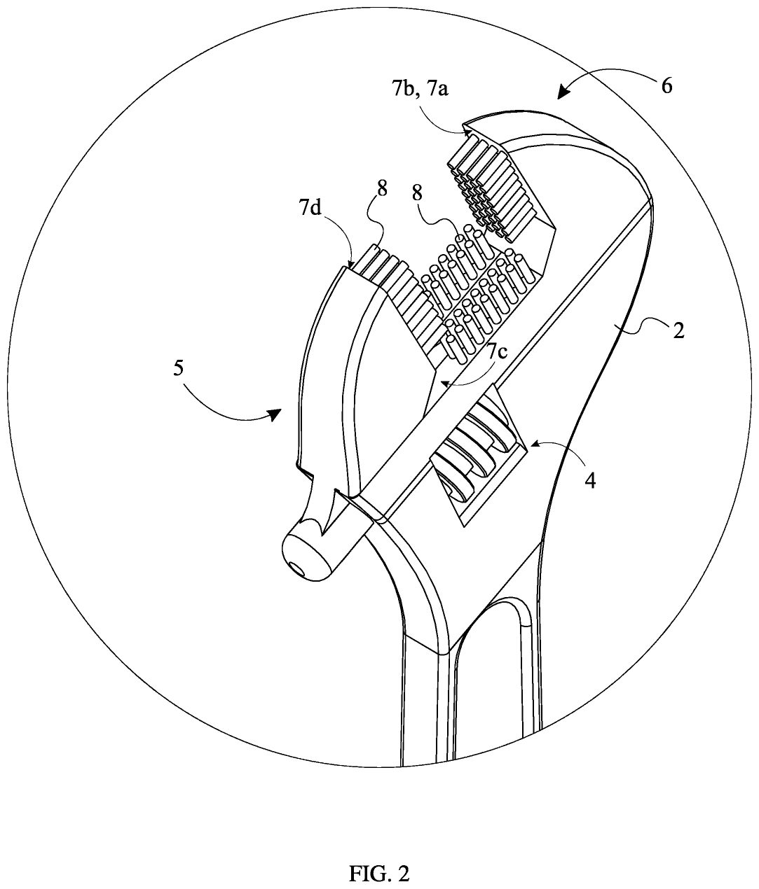

As seen in FIG. 2, the movable jaw 5 and the fixed jaw 6 comprises a plurality of planar surfaces 7. In order to clean the stroller wheel from multiple directions, the plurality of brush heads 3 is mounted onto the wrench head 2 in such a way that each of the plurality of brush heads 3 is mounted onto a corresponding planar surface 7a, wherein the corresponding planar surface 7a is from the plurality of planar surfaces 7. Further, each of the plurality of brush heads 3 comprises a plurality of bristles 8, wherein the plurality of bristles 8 is embedded onto each of the plurality of planar surfaces 7. Preferably, the plurality of bristles 8 is made of a semi rigid nylon material similar to that of a standard broom. However, the plurality of brush heads and the plurality of bristles may comprise any other size, shape, material etc. that are known to one of ordinary skill in the art, as long as the intents of the present invention are not altered.

According to the preferred embodiment, the length adjusting device 4 is mounted within the wrench head 2. Preferably, the length adjusting device 4 is a mechanical inner wrench adjuster wherein the length adjusting device 4 enables lateral movement of the movable jaw 5 towards and away from the fixed jaw 6. More specifically, the length adjusting device 4 is operably integrated onto the wrench head 2, such that operating the length adjusting device 4 governs the spacing between the plurality of brush heads 3 on the movable jaw 5 and the fixed jaw 6. In the preferred embodiment, the length adjusting device 4 comprises a rotatable screw that when operated governs the distance between the jaws of the wrench. However, the length adjusting device 4 may include any other components, technology, and positioning, as long as the objectives of the present invention are fulfilled.

A more detailed description of the components of the present invention follows. According to the preferred embodiment, the plurality of planar surfaces 7 comprises a first planar surface 7b, a second planar surface 7c, and a third planar surface 7d. As seen in FIG. 1 and FIG. 2, the first planar surface 7b is positioned normal to the second planar surface 7c, wherein the first planar surface 7b and the second planar surface 7c are part of the fixed jaw 6 of the wrench head 2. Further, the third planar surface 7d is oriented parallel to the first planar surface 7b, wherein the third planar surface 7d is part of the movable jaw 5. The positioning of the first planar surface 7b, the second planar surface 7c and the third planar surface 7d enables better access and reach for the apparatus to clean different surfaces on the stroller wheel. To that end, the plurality of brush heads 3 comprises a first brush head 3a, a second brush head 3b, and a third brush head 3c. Preferably, the first brush 3a head is mounted onto the first planar surface 7b, the second brush head 3b is mounted onto the second planar surface 7c, and the third brush head 3c is mounted onto the third planar surface 7d. Furthermore, the first brush head 3a extends from the first planar surface 7b towards the third planar surface 7d, the third brush head 3c extends from the third planar surface 7d towards the first planar surface 7a, and the second brush head 3b extends from the second planar surface 7c and is oriented normal to the first brush head 3a and the third brush head 3d. In other words, the first brush head 3a, the second brush head 3b, and the third brush head 3c help to clean stroller wheels from three different directions. Thus, the orientation of the plurality of brush heads 3 enables with the multidirectional cleaning in a single stroke with the present invention.

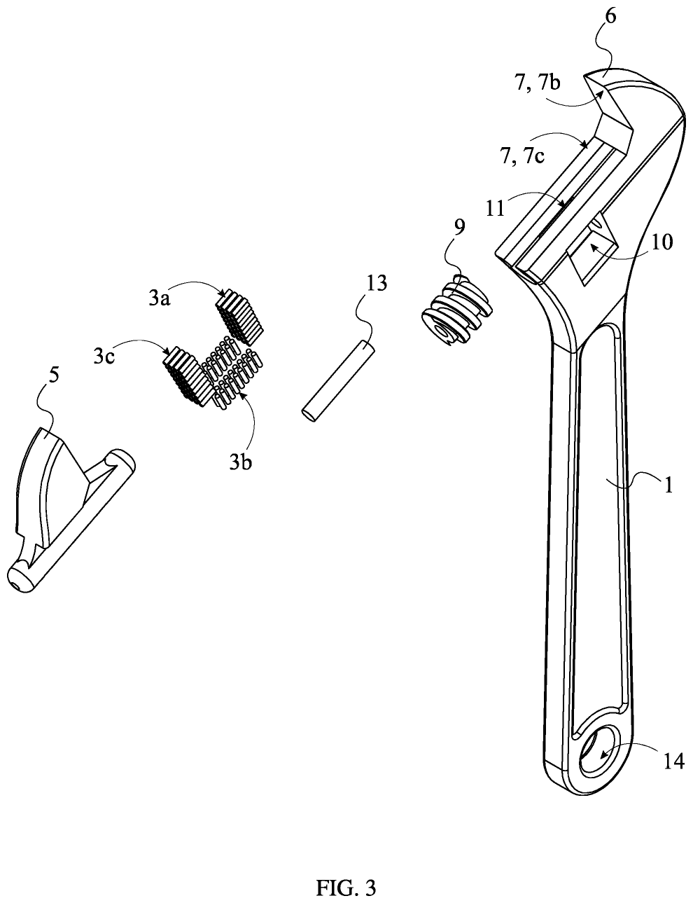

In reference to FIG. 3, the length adjusting device 4 comprises a thumb screw 9, an access port 10, a crevice 11, a pinhole 12, and a pin 13. Preferably, the thumb screw 9 is rotatably engaged with a rigged surface 5a of the movable jaw 5, such that the user may operate the thumb screw 9 to adjust the distance between the movable jaw 5 and the fixed jaw 6 of the wrench head 2. Further, the pin hole 12 laterally traverses through the wrench head 2 opposite to the movable jaw 5, such that the pin 13 is threaded through the pin hole 12. In order to enable smooth functioning of the length adjustable device 4, the pin 13 is engaged centrally along the thumb screw 9. In other words, the pin 13 acts as the anchor that holds the different components of the length adjusting device 4 together. In order for the user to access and operate the thumb screw 9 and thus enable length adjustment, the access port 10 laterally traverses through the wrench head 2, and the thumb screw 9 is positioned within the access port 10. Furthermore, the crevice 11 extends normally along the second planar surface 7c of the wrench head 2, opposite to the fixed jaw 6, such that the movable jaw 5 is slidably engaged within the crevice 11. Thus, in the preferred embodiment, operating the thumb screw 9 through the access port 10 governs lateral motion of the movable jaw 5 along the crevice 11.

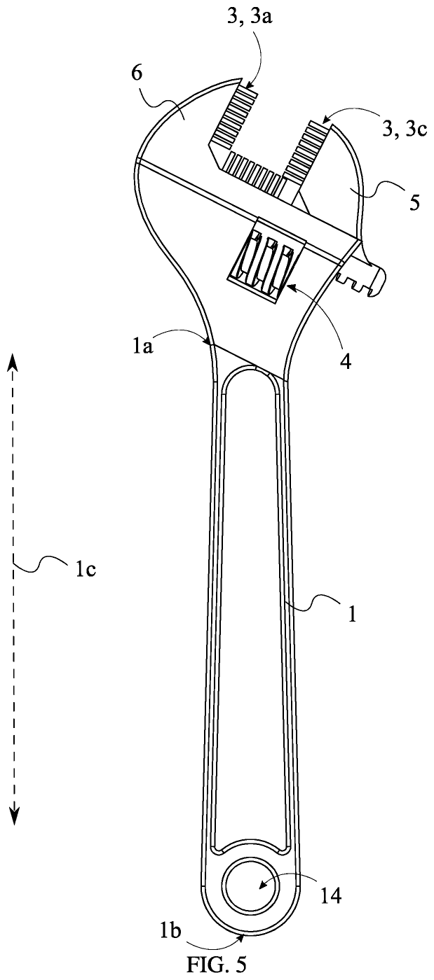

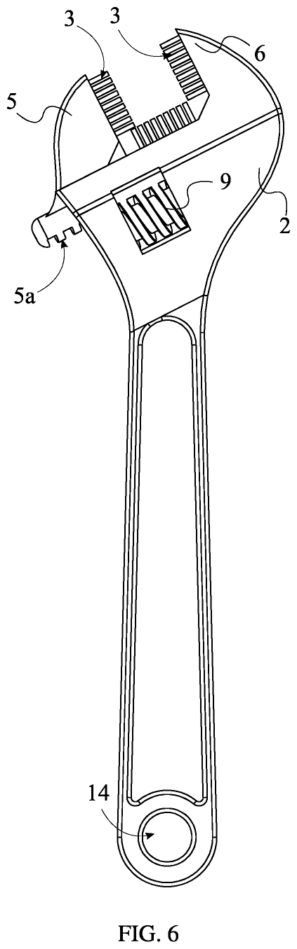

As seen in FIG. 5 and FIG. 6, the wrench head is angularly offset along a longitudinal axis 1c of the handle. This offset angle and positioning of the wrench head allows the user to use the apparatus in confined spaces as well as on flat surfaces.

As seen in FIG. 1 and FIG. 3 through FIG. 6, the present invention comprises an accessory port 14. Preferably, the accessory port 14 traverses through the handle 1 and may be used to hang the cleaning apparatus from various hooks, nails and other hanger points. To that end, the accessory port 14 is positioned adjacent a second terminal end 1b of the handle 1, wherein the second terminal end 1b is positioned opposite to the first terminal end 1a across the handle 1. In other words, the accessory port 14 is a hole positioned adjacent a bottom end of the handle 1. However, the accessory port 14 may comprise any other shape, size, and positioning, as long as the intents of the present invention are not altered.

Although the invention has been explained in relation to its preferred embodiment, it is to be understood that many other possible modifications and variations can be made without departing from the spirit and scope of the invention as hereinafter claimed.

What is claimed is:

1. An adjustable stroller wheel cleaning device comprising:
a handle;
a wrench head;
a plurality of brush heads;
a length adjusting device;
the wrench head comprising a movable jaw and a fixed jaw;
the movable jaw and the fixed jaw comprising a plurality of planar surfaces;
the wrench head being connected to a first terminal end of the handle;
each of the plurality of brush heads being mounted onto a corresponding planar surface, wherein the corresponding planar surface is from the plurality of planar surfaces;
the length adjusting device being mounted within the wrench head; and
the length adjusting device being operably integrated onto the wrench head, such that operating the length adjusting device governs the spacing between the plurality of brush heads on the movable jaw and the fixed jaw.

2. The stroller brush cleaning device of claim 1, wherein each of the plurality of brush heads comprising:
a plurality of bristles; and
the plurality of bristles being embedded onto each of the plurality of planar surfaces.

3. The stroller brush cleaning device of claim 1, wherein the length adjusting device enables lateral movement of the movable jaw towards and away from the fixed jaw.

4. The stroller brush cleaning device of claim 1, comprising:
the plurality of planar surfaces comprising a first planar surface, a second planar surface, and a third planar surface;
the first planar surface being positioned normal to the second planar surface;
the first planar surface and the second planar surface being part of the fixed jaw of the wrench head;
the third planar surface being oriented parallel to the first planar surface; and
the third planar surface being part of the movable jaw.

5. The stroller brush cleaning brush of claim 4, comprising:
the plurality of brush heads comprising a first brush head, a second brush head, and a third brush head;
the first brush head being mounted onto the first planar surface;
the second rush head being mounted onto the second planar surface;
the third brush head being mounted onto the third planar surface;
the first brush head extending from the first planar surface towards the third planar surface;
the third brush head extending from the third planar surface towards the first planar surface; and
the second brush head extending from the second planar surface and being oriented normal to the first brush head and the third brush head.

6. The stroller brush cleaning device of claim 1, the length adjusting device comprising:
a thumb screw, an access port, a crevice, a pinhole, and a pin;
the thumb screw being rotatably engaged with a rigged surface of the movable jaw;
the pin hole laterally traversing through the wrench head opposite to the movable jaw;
the pin being threaded through the pin hole;
the pin being engaged centrally along the thumb screw;
the access port laterally traversing through the wrench head;
the thumb screw being positioned within the access port;
the crevice extending normally along a second planar surface of the wrench head, opposite to the fixed jaw; and
the movable jaw being slidably engaged within the crevice.

7. The stroller brush cleaning device of claim 6, wherein operating the thumb screw through the access port governs lateral motion of the movable jaw along the crevice.

8. The stroller brush cleaning device of claim 1, wherein the wrench head being angularly offset along a longitudinal axis of the handle.

9. The stroller brush cleaning device of claim 1, comprising:
an accessory port;
the accessory port traversing through the handle; and
the accessory port being positioned adjacent a second terminal end of the handle, wherein the second terminal end being positioned opposite to the first terminal end across the handle.

10. An adjustable stroller wheel cleaning device comprising:
a handle;
a wrench head;
a plurality of brush heads;
a plurality of bristles;
a length adjusting device;
the wrench head comprising a movable jaw and a fixed jaw;
the movable jaw and the fixed jaw comprising a plurality of planar surfaces;
the wrench head being connected to a first terminal end of the handle;
each of the plurality of brush heads being mounted onto a corresponding planar surface, wherein the corresponding planar surface is from the plurality of planar surfaces;
the plurality of bristles being embedded onto each of the plurality of planar surfaces;
the length adjusting device being mounted within the wrench head, wherein the length adjusting device enables lateral movement of the movable jaw towards and away from the fixed jaw; and
the length adjusting device being operably integrated onto the wrench head, such that operating the length adjusting device governs the spacing between the plurality of brush heads on the movable jaw and the fixed jaw.

11. The stroller brush cleaning device of claim 10, comprising:
the plurality of planar surfaces comprising a first planar surface, a second planar surface, and a third planar surface;
the first planar surface being positioned normal to the second planar surface;
the first planar surface and the second planar surface being part of the fixed jaw of the wrench head;
the third planar surface being oriented parallel to the first planar surface; and
the third planar surface being part of the movable jaw.

12. The stroller brush cleaning brush of claim 11, comprising:
the plurality of brush heads comprising a first brush head, a second brush head, and a third brush head;
the first brush head being mounted onto the first planar surface;
the second rush head being mounted onto the second planar surface;
the third brush head being mounted onto the third planar surface;
the first brush head extending from the first planar surface towards the third planar surface;
the third brush head extending from the third planar surface towards the first planar surface; and
the second brush head extending from the second planar surface and being oriented normal to the first brush head and the third brush head.

13. The stroller brush cleaning device of claim 10, the length adjusting device comprising:
a thumb screw, an access port, a crevice, a pinhole, and a pin;
the thumb screw being rotatably engaged with a rigged surface of the movable jaw;
the pin hole laterally traversing through the wrench head opposite to the movable jaw;
the pin being threaded through the pin hole;
the pin being engaged centrally along the thumb screw;
the access port laterally traversing through the wrench head;
the thumb screw being positioned within the access port;
the crevice extending normally along a second planar surface of the wrench head, opposite to the fixed jaw; and
the movable jaw being slidably engaged within the crevice.

14. The stroller brush cleaning device of claim 13, wherein operating the thumb screw through the access port governs lateral motion of the movable jaw along the crevice.

15. An adjustable stroller wheel cleaning device comprising:
a handle;
a wrench head;
a plurality of brush heads;
a plurality of bristles;
a length adjusting device;
the wrench head comprising a movable jaw and a fixed jaw;
the wrench head comprising a first planar surface, a second planar surface, and a third planar surface;
the wrench head being connected to a first terminal end of the handle;
each of the plurality of brush heads being mounted onto a corresponding planar surface, wherein the corresponding planar surface is from the plurality of planar surfaces;
the plurality of bristles being embedded onto each of the plurality of planar surfaces;
the first planar surface being positioned normal to the second planar surface;
the first planar surface and the second planar surface being part of the fixed jaw of the wrench head;
the third planar surface being oriented parallel to the first planar surface;
the third planar surface being part of the movable jaw;
the length adjusting device being mounted within the wrench head, wherein the length adjusting device enables lateral movement of the movable jaw towards and away from the fixed jaw; and
the length adjusting device being operably integrated onto the wrench head, such that operating the length adjusting device governs the spacing between the plurality of brush heads on the movable jaw and the fixed jaw.

16. The stroller brush cleaning brush of claim 15, comprising:
the plurality of brush heads comprising a first brush head, a second brush head, and a third brush head;
the first brush head being mounted onto the first planar surface;
the second rush head being mounted onto the second planar surface;
the third brush head being mounted onto the third planar surface;
the first brush head extending from the first planar surface towards the third planar surface;
the third brush head extending from the third planar surface towards the first planar surface; and
the second brush head extending from the second planar surface and being oriented normal to the first brush head and the third brush head.

17. The stroller brush cleaning device of claim 15, the length adjusting device comprising:
a thumb screw, an access port, a crevice, a pinhole, and a pin;
the thumb screw being rotatably engaged with a rigged surface of the movable jaw;
the pin hole laterally traversing through the wrench head opposite to the movable jaw;
the pin being threaded through the pin hole;
the pin being engaged centrally along the thumb screw;
the access port laterally traversing through the wrench head;
the thumb screw being positioned within the access port;
the crevice extending normally along a second planar surface of the wrench head, opposite to the fixed jaw; and
the movable jaw being slidably engaged within the crevice.

18. The stroller brush cleaning device of claim 17, wherein operating the thumb screw through the access port governs lateral motion of the movable jaw along the crevice.

19. The stroller brush cleaning device of claim 15, wherein the wrench head being angularly offset along a longitudinal axis of the handle.

20. The stroller brush cleaning device of claim 15, comprising:
an accessory port;
the accessory port traversing through the handle;
the accessory port being positioned adjacent a second terminal end of the handle, wherein the second terminal end being positioned opposite to the first terminal end across the handle.
